(19) United States
(12) Patent Application Publication
(10) Pub. No.: US 2026/0346562 A1
(43) Pub. Date: Nov. 5, 2026

(54) PREFORM MACHINED CERAMIC MATRIX COMPOSITE INVOLUTE LAYUP AND METHOD

(71) Applicant: RTX Corporation, Farmington, CT (US)

(72) Inventors: Russell KIM, Temecula, CA (US); Jonas BANHOS, West Hartford, CT (US); James T. ROACH, Vernon, CT (US)

(73) Assignee: RTX Corporation, Farmington, CT (US)

(21) Appl. No.: 19/742,159

(22) Filed: Jul. 15, 2026

Related U.S. Application Data
(63) Continuation-in-part of application No. 19/053,201, filed on Feb. 13, 2025.

(51) Int. Cl. B32B 1/00; B32B 3/10; B32B 5/26; B32B 38/10

(52) U.S. Cl. CPC B32B 1/00; B32B 3/10; B32B 5/26; B32B 38/10

(57) ABSTRACT

Tolerances of full hoop or segmented ceramic matrix composite (CMC) parts may be controlled by utilizing machining methods earlier in the fabrication process on an involute stack of plies. In an embodiment, a plurality of fabric plies having a tackifier are stacked in a partially overlapping manner to form an involute stack of fabric plies forming a hoop or portion thereof, which may have a cylindrical or conical axial profile. The inner diameter (ID) and outer diameter (OD) surfaces of the involute stack of fabric plies are then machined to remove lap joint discontinuities and/or other uneven surfaces. The machined ID and OD surfaces are then overwrapped with an inner mold layer (IML) overwrap and outer mold layer (OML) overwrap formed of one or more plies of fabric to form a preform, which may then be densified.

### RELATED APPLICATIONS

This application is a continuation-in-part of U.S. Application Serial No. 19/053,201, filed on Feb. 13, 2025, which is incorporated herein by reference in its entirety.

### FIELD OF THE INVENTION

The subject matter disclosed herein relates to full hoop or segmented ceramic matrix composite (CMC) preforms for gas turbine components and, in particular, to a machined full hoop or segmented CMC preform for such components from an involute layup.

### BACKGROUND OF THE INVENTION

Gas turbine engines or jet engines, in general, include a fan section, a compressor section, a combustion section, and a turbine section. Air enters through the fan section and is compressed in the compressor section before being introduced into the combustion section. In the combustion section, the air is mixed with fuel and ignited to generate a high-energy, high temperature gas flow. The high-energy, high temperature gas flow is expanded in the turbine section which is used to create thrust and to drive the compressor and fan sections.

Certain components of gas turbine engines are thus exposed to the high-energy, high temperature gas flow (i.e., gaspath components). Therefore, it is desirable that such components be made of heat-resistant materials such as ceramic matrix composites (CMCs), which can withstand much higher operating temperatures than components composed of metal superalloys. Silicon Carbide (SiC) based CMCs fabricated via Chemical Vapor Infiltration (CVI), Melt Infiltration (MI), Polymer Infiltration and Pyrolysis (PIP), and hybrids of CVI/MI and CVI/PIP possess such high temperature capability. Such CMC components are typically fabricated from a near-net shape fiber preform, typically formed from fabric and tow layups.

However, full hoop or segmented components can be challenging to create and control within tolerances by solely folding fabric. The fabric of a preform can exhibit distortion of tow orientation and wrinkling when trying to achieve conformity. Accordingly, post-densification machining of such CMC components is often required.

The above information disclosed in this Background section is only for understanding of the background of the inventive concepts and, therefore, it may contain information that does not constitute prior art.

### SUMMARY OF THE INVENTION

The present disclosure is directed, in a first aspect, to a ceramic matrix composite (CMC) component or preform thereof. The component or preform includes an involute stack of fabric plies formed of a plurality of partially overlapping inwardly-curved tackified fabric plies so as to have an inner diameter (ID) surface and an outer diameter (OD) surface, wherein the ID surface and OD surface are machined prior to densification to remove lap joint discontinuities. An inner mold layer overwrap formed of one or more tackified fabric plies is disposed to overwrap the ID surface prior to densification, and an outer mold layer overwrap formed of one or more tackified fabric plies is disposed to overwrap the OD surface prior to densification.

In further embodiments of the present disclosure, including further embodiments of the above and below exemplary embodiments, the involute stack of fabric plies may form a full hoop.

In further embodiments of the present disclosure, including further embodiments of the above and below exemplary embodiments, the tackified fabric plies may include polyvinyl acetate (PVA) as a tackifier.

In further embodiments of the present disclosure, including further embodiments of the above and below exemplary embodiments, the tackified fabric plies may include polyvinyl butyral (PVB) as a tackifier.

In further embodiments of the present disclosure, including further embodiments of the above and below exemplary embodiments, when the involute stack of fabric plies forms a full hoop, the full hoop may be conical.

In further embodiments of the present disclosure, including further embodiments of the above and below exemplary embodiments, when the involute stack of fabric plies forms a full hoop, an orientation of the plies in the involute stack of fabric plies relative to an axis of the full hoop may be selected based upon strength and/or performance requirements of the CMC component after densification.

In further embodiments of the present disclosure, including further embodiments of the above and below exemplary embodiments, the involute stack of fabric plies may form a segment of a hoop.

In further embodiments of the present disclosure, including further embodiments of the above and below exemplary embodiments, when the involute stack of fabric plies forms a full hoop, the full hoop may be segmented after densification.

In further embodiments of the present disclosure, including further embodiments of the above and below exemplary embodiments, when the involute stack of fabric plies forms a full hoop, the full hoop may be segmented prior to densification.

The present disclosure is also directed, in a further aspect, to a method of forming a ceramic matrix composite (CMC) component. The method includes stacking a plurality of inwardly-curved tackified fabric plies in a partially overlapping manner to form an involute stack of fabric plies. The method also includes machining an inner diameter (ID) surface and an outer diameter (OD) surface of the involute stack of fabric plies to remove lap joint discontinuities. The method further includes overwrapping the ID surface with an inner mold layer overwrap formed of one or more plies of fabric, and overwrapping the OD surface with an outer mold layer overwrap formed of one or more plies of fabric, so as to form a preform.

In further embodiments of the present disclosure, including further embodiments of the above and below exemplary embodiments, a method may further include densifying the preform to form the CMC component.

In further embodiments of the present disclosure, including further embodiments of the above and below exemplary embodiments, the inner mold layer overwrap and the outer mold layer overwrap may also include a tackifier.

In further embodiments of the present disclosure, including further embodiments of the above and below exemplary embodiments, the tackifier may be polyvinyl acetate (PVA) and/or polyvinyl butyral (PVB).

In further embodiments of the present disclosure, including further embodiments of the above and below exemplary embodiments, the involute stack of fabric plies may be conical.

In further embodiments of the present disclosure, including further embodiments of the above and below exemplary embodiments, the involute stack of fabric plies may form a full hoop.

In further embodiments of the present disclosure, including further embodiments of the above and below exemplary embodiments, when the involute stack of fabric plies forms a full hoop, an orientation of plies in the involute stack of fabric plies relative to an axis of the full hoop may be selected based upon strength and/or performance requirements of the airfoil component after densifying the preform.

The present disclosure is further directed, in another aspect, to a method of forming a full hoop ceramic matrix composite (CMC) component. This method includes forming a full hoop preform by: stacking a plurality of inwardly-curved tackified fabric plies in a partially overlapping manner to form a hoop-shaped involute stack of fabric plies; machining an inner diameter (ID) surface and an outer diameter (OD) surface of the involute stack of fabric plies to remove lap joint discontinuities; overwrapping the ID surface with an inner mold layer overwrap formed of one or more tackified fabric plies; and overwrapping the OD surface with an outer mold layer overwrap formed of one or more tackified fabric plies. The method further includes densifying the full hoop preform to form the full hoop CMC component.

In further embodiments of the present disclosure, including further embodiments of the above and below exemplary embodiments, a tackifier of the tackified fabric plies may be polyvinyl acetate (PVA) and/or polyvinyl butyral (PVB).

In further embodiments of the present disclosure, including further embodiments of the above and below exemplary embodiments, the hoop-shaped involute stack of fabric plies may be conical.

In further embodiments of the present disclosure, including further embodiments of the above and below exemplary embodiments, an orientation of plies in the hoop-shaped involute stack of fabric plies relative to an axis of the full hoop may be selected based upon strength and/or performance requirements of the full hoop CMC component after densifying the full hoop preform.

### BRIEF DESCRIPTION OF FIGURES

The features of the disclosure believed to be novel and the elements characteristic of the invention are set forth with particularity in the appended claims. The figures are for illustration purposes only and are not drawn to scale. The disclosure itself, however, both as to organization and method of operation, can best be understood by reference to the description of the preferred embodiment(s) which follows, taken in conjunction with the accompanying drawings in which:

FIG. 1A schematically illustrates an axial view of an example tackified involute ply stack forming a hoop in accordance with the present disclosure;

FIG. 1B schematically illustrates an axial view of an example tackified involute ply stack that has been machined in accordance with the present disclosure;

FIG. 1C schematically illustrates an axial view of an example the machined ply stack of FIG. 1B assembled with overwrap plies in accordance with the present disclosure;

FIG. 2 is a flow diagram of an example process in accordance with the present disclosure

FIG. 3 schematically illustrates an axial view of an example segmented preform or part in accordance with the present disclosure; and

FIG. 4 schematically illustrates a side view of an example conical preform or part in accordance with the present disclosure.

### DETAILED DESCRIPTION OF THE INVENTION

The embodiments of the present disclosure can comprise, consist of, and consist essentially of the features and/or steps described herein, as well as any of the additional or optional ingredients, components, steps, or limitations described herein or would otherwise be appreciated by one of skill in the art.

The following discussion omits or only briefly describes conventional features of the disclosed technology that are apparent to those skilled in the art. Reference to a particular embodiment does not limit the scope of the claims attached hereto. Additionally, any examples set forth in this specification are intended to be non-limiting and merely set forth some of the many possible embodiments for the appended claims. Further, particular features described herein can be used in combination with other described features in each of the various possible combinations and permutations. A person of ordinary skill in the art would know how to use the instant invention, in combination with routine experiments, to achieve other outcomes not specifically disclosed in the examples or the embodiments.

Unless otherwise specifically defined herein, all terms are to be given their broadest possible interpretation including meanings implied from the specification as well as meanings understood by those skilled in the art and/or as defined in dictionaries, treatises, etc. Unless defined otherwise, all technical and scientific terms used herein have the same meaning as commonly understood by one of ordinary skill in the art in the field of the disclosed technology. It must also be noted that, as used in the specification and the appended claims, the singular forms “a,” “an,” and “the” include plural referents unless otherwise specified, and that the terms "includes" and/or "including," when used in this specification, specify the presence of stated features, elements, and/or components, but do not preclude the presence or addition of one or more other features, steps, operations, elements, components, and/or groups thereof. Additionally, methods, equipment, and materials similar or equivalent to those described herein can also be used in the practice or testing of the disclosed technology.

The devices of the present disclosure may be understood more readily by reference to the following detailed description of the embodiments taken in connection with the accompanying drawing figures, which form a part of this disclosure. It is to be understood that this application is not limited to the specific devices, methods, conditions or parameters described and/or shown herein, and that the terminology used herein is for the purpose of describing particular embodiments by way of example only and is not intended to be limiting. All spatial references, such as, for example, proximal, distal, horizontal, vertical, top, upper, lower, bottom, left and right, are for illustrative purposes only and can be varied within the scope of the disclosure. For example, the references “upper” and “lower” are relative and used only in the context to the other, and are not necessarily “superior” and “inferior.”

It will further be understood that, although the terms “first,” “second,” “third,” and the like may be used herein to describe various elements, these elements should not be limited by these terms. These terms are only used to distinguish one element from another element. Thus, “a first element” discussed below could be termed “a second element” or “a third element,” and “a second element” and “a third element” may be termed likewise without departing from the teachings herein.

Various examples of the disclosed technology are provided throughout this disclosure. The use of these examples is illustrative only, and in no way limits the scope and meaning of the invention or of any exemplified form. Likewise, the invention is not limited to any particular preferred embodiment(s) described herein. Indeed, modifications and variations of the invention may be apparent to those skilled in the art upon reading this specification, and can be made without departing from its spirit and scope. The invention is therefore to be limited only by the terms of the claims, along with the full scope of equivalents to which the claims are entitled.

The present disclosure is directed to controlling tolerances of full hoop or segmented ceramic matrix composite (CMC) parts by utilizing machining methods earlier in the fabrication process on an involute stack of plies. In accordance with the present disclosure, a plurality of fabric plies having a tackifier are stacked in a partially overlapping manner to form an involute stack of fabric plies forming a hoop or portion thereof, which may have a cylindrical or conical axial profile (see, e.g., conical hoop preform/part 440 of FIG. 4). The inner diameter (ID) and outer diameter (OD) surfaces of the involute stack of fabric plies are then machined to remove lap joint discontinuities and/or other uneven surfaces. The machined ID and OD surfaces are then overwrapped with an inner mold layer (IML) overwrap and outer mold layer (OML) overwrap formed of one or more plies of fabric to form a preform, which may then be densified.

As used herein, the term “involute stack of plies” refers to a stack of plies wherein each ply is curled inward. Although shown as a full hoop, an involute stack of plies may be less than a full hoop or a segment thereof without departing from the present disclosure.

In the discussion below, axial refers to a direction that coincides with the longitudinal axis of the engine. Radial refers to a direction that is radial with respect to the longitudinal axis of the engine. Circumferential refers to a direction that corresponds to the circumference of a circle around the longitudinal axis of the engine. The leading edge/portion of a structure is the edge/portion that faces into the flow of the hot gases, i.e., faces upstream. The trailing edge/portion of a structure is the edge/portion that the faces away from the flow of the hot gases, i.e., faces downstream.

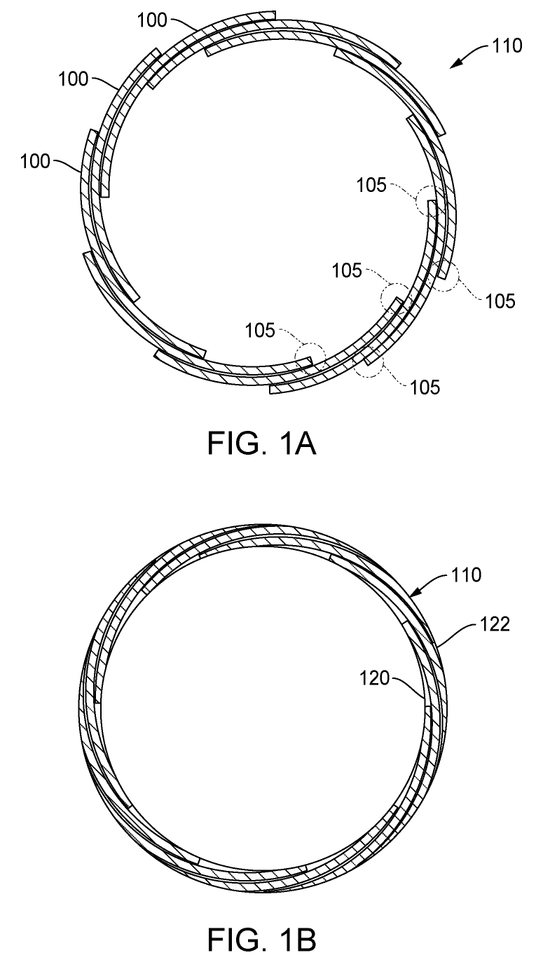

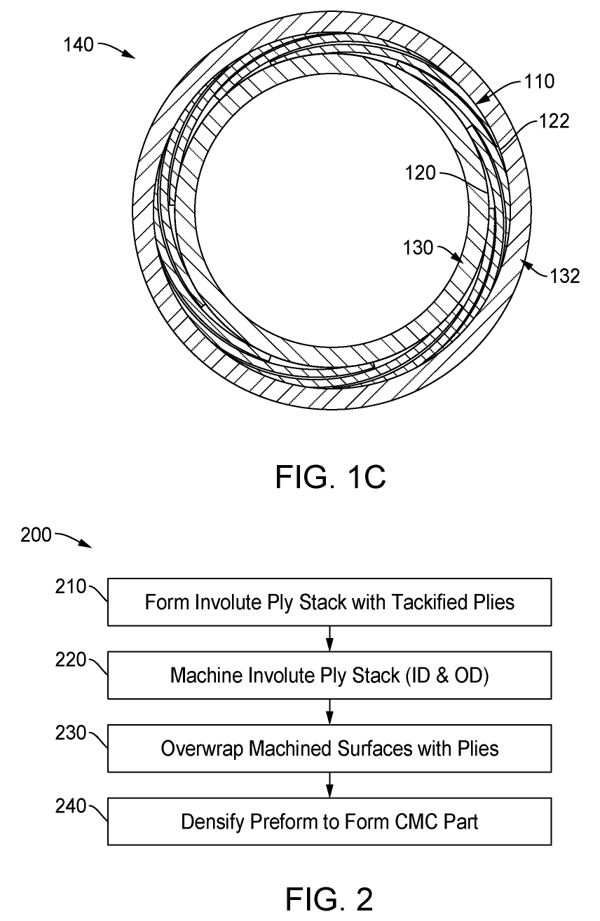

FIGS. 1A, 1B, and 1C, illustrate various stages of forming full hoop preform 140 having a cylindrical or conical shape of a CMC component for a gas turbine engine.

With reference to FIG. 1A, a plurality of fabric plies 100 may be stacked having an inward curve and in a partially overlapping manner to form an involute stack of fabric plies 110. The fabric plies may include a tackifier, such as polyvinyl acetate (PVA) or polyvinyl butyral (PVB) in order to adhere the plurality of fabric plies together and form the involute stack of plies 110. In an embodiment, each ply of fabric, which may be formed from SiC fibers, includes the tackifier on one side thereof such that the involute stack of fabric plies 110 may be held together and have sufficient rigidity to be machined.

When stacked, the curve of each of the fabric plies 100 in the involute stack of fabric plies 110 may be have a same involute inward curvature. In one or more embodiments of the present disclosure, an orientation of the fabric plies 100 relative to the axis of the involute stack of fabric plies 110 may be uniform or may be selected or varied to provide desired strength and/or performance characteristics/requirements of a finished (i.e., densified) CMC component.

The size of the involute stack of fabric plies 110 should be sufficient to form a hoop-shape or curved billet for machining the desired component. Indeed, the hoop-shape or curved billet will need to be slightly oversized since the involute stack of fabric plies 110 will have lap joints 105 on the inner diameter (ID) and outer diameter (OD) thereof that form discontinuities which will be machined off in the next step.

With reference to FIG. 1B, the ID surface 120 and the OD surface 122 of the involute stack of fabric plies 110 may be machined into a desired hoop or segment shape that will be smooth based on the machining away the discontinuities of the lap joints 105 from FIG. 1A.

Machining the ID surface 120 and the OD surface 122 of the involute stack of fabric plies 110 may be performed in any suitable manner, including but not limited to traditional milling and grinding, ultrasonic impact grinding, laser etching, water guided laser machining, and the like.

With reference to FIG. 1C, a preform 140 for a full hoop or segmented CMC component may be formed by overwrapping the ID surface 120 with an inner mold layer (IML) overwrap 130 and overwrapping the OD surface 122 with an outer mold layer (OML) overwrap 132. IML overwrap 130 and OML overwrap 132 may include one or more overwrapped fabric plies that include a tackifier and, together, wrap fully around the machined ID surface 120 and OD surface 122 to cover exposed edges of the plies 100.

IML overwrap 130 and OML overwrap 132 provide reinforcement to the preform 140 by reinforcing the involute stack of plies 110 in the interlaminar direction of the fabric plies 100 (i.e., direction transverse to the fabric plies 100). IML overwrap 130 and OML overwrap 132 also provide protection to the exposed edges of the fabric plies 100 and may smooth any minor surface imperfections on machined ID surface 120 and machined OD surface 122.

With reference to FIG. 2, an embodiment of a method 200 of forming a CMC component or preform thereof is illustrated in a flow diagram.

A first step 210 of method 200 includes forming an involute ply stack with tackified plies that will act as a billet for machining. In an embodiment, this step includes stacking a plurality of inwardly curved fabric plies in a partially overlapping manner to form the involute stack of fabric plies. In various embodiments of the present disclosure, the tackifier material may be PVA or PVB. While PVA and PVB are included herein as exemplary tackifiers, embodiments in accordance with the present disclosure are not limited thereto, and any suitable tackifier substance may be used without departing from the present disclosure.

A next step 220 of method 200 includes machining the involute ply stack into a desired shape. This may include machining an ID surface of the involute ply stack and machining an OD surface of the involute ply stack to remove lap joint discontinuities and/or other uneven surfaces. The machining in step 220 may be performed in any suitable manner, including but not limited to traditional milling and grinding, ultrasonic impact grinding, laser etching, water guided laser machining, and the like.

In an embodiment, an orientation of one or more plies in the involute ply stack relative to the hoop axis may be selected based upon strength and/or performance requirements of the component (after densifying the preform).

Method 200 continues with step 230, which includes overwrapping the machined ID surface with an inner mold layer overwrap formed of one or more plies of tackified fabric and overwrapping the machined OD surface with an outer mold layer overwrap formed of one or more plies of tackified fabric to form a preform for a CMC component (i.e., part preform).

In various embodiments of this embodiment of method 200, the tackifier may be polyvinyl acetate (PVA) or polyvinyl butyral (PVB).

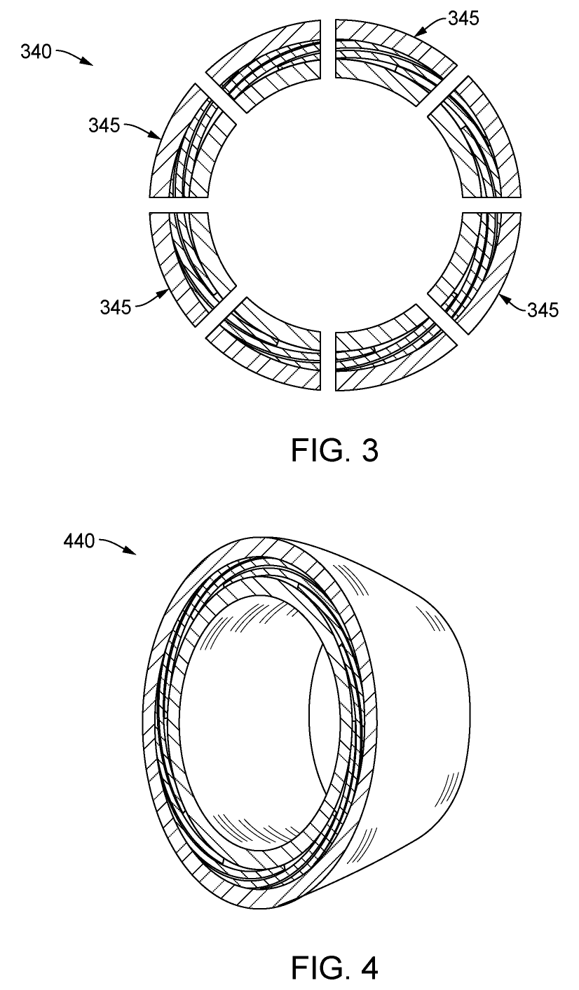

In one or more embodiments of the present disclosure, method 200 may include a step 240 to densify the part preform, i.e., densifying the preform to form the CMC component. In one or more embodiments, step 240 may include densifying the preform via chemical vapor infiltration (CVI), melt infiltration (MI), polymer infiltration and pyrolysis (PIP), and/or hybrids of CVI/MI and CVI/PIP. In one or more embodiments, as illustrated by preform or part 340 of FIG. 3, the preform 340 may be segmented (by machining) and then densified into segments 345, or a hoop shaped preform 340 may be densified and then segmented (by machining) into segments 345.

Embodiments within the present disclosure provide numerous benefits, including but not limited to providing flexibility and greater control with respect to creating hoop shaped or conical profiles and shapes, simplifying and reducing preform manufacturing lead times, and providing the ability to control orientation of fabric plies to meet strength and performance requirements of the resulting part. Embodiments in accordance with the present disclosure further reduce the challenges of folding fabric plies to conform to specific shapes.

While the present disclosure has been particularly described, in conjunction with specific preferred embodiments, it is evident that many alternatives, modifications and variations will be apparent to those skilled in the art in light of the foregoing description. It is therefore contemplated that the appended claims will embrace any such alternatives, modifications and variations as falling within the true scope and spirit of the present disclosure.

What is claimed is:

1. A ceramic matrix composite (CMC) component or preform thereof, comprising:
an involute stack of fabric plies formed of a plurality of partially overlapping inwardly-curved tackified fabric plies so as to have an inner diameter (ID) surface and an outer diameter (OD) surface, wherein the ID surface and OD surface are machined prior to densification to remove lap joint discontinuities;
an inner mold layer overwrap formed of one or more tackified fabric plies and disposed to overwrap the ID surface prior to densification; and
an outer mold layer overwrap formed of one or more tackified fabric plies and disposed to overwrap the OD surface prior to densification.

2. The CMC airfoil component or preform thereof of claim 1, wherein the involute stack of fabric plies forms a full hoop.

3. The CMC airfoil component or preform thereof of claim 1, wherein the tackified fabric plies include polyvinyl acetate (PVA) as a tackifier.

4. The CMC airfoil component or preform thereof of claim 1, wherein the tackified fabric plies include polyvinyl butyral (PVB) as a tackifier.

5. The CMC airfoil component or preform thereof of claim 2, wherein the full hoop is conical.

6. The CMC airfoil component or preform thereof of claim 2, wherein an orientation of the plies in the involute stack of fabric plies relative to an axis of the full hoop is selected based upon strength and/or performance requirements of the CMC component after densification.

7. The CMC airfoil component or preform thereof of claim 1, wherein the involute stack of fabric plies forms a segment of a hoop.

8. The CMC airfoil component or preform thereof of claim 2, wherein the full hoop is segmented after densification.

9. The CMC airfoil component or preform thereof of claim 2, wherein the full hoop is segmented prior to densification.

10. A method of forming a ceramic matrix composite (CMC) component, comprising:
stacking a plurality of inwardly-curved tackified fabric plies in a partially overlapping manner to form an involute stack of fabric plies;
machining an inner diameter (ID) surface and an outer diameter (OD) surface of the involute stack of fabric plies to remove lap joint discontinuities;
overwrapping the ID surface with an inner mold layer overwrap formed of one or more plies of fabric; and
overwrapping the OD surface with an outer mold layer overwrap formed of one or more plies of fabric,
so as to form a preform.

11. The method of claim 10, further comprising densifying the preform to form the CMC component.

12. The method of claim 11, wherein the inner mold layer overwrap and the outer mold layer overwrap also include a tackifier.

13. The method of claim 12, wherein the tackifier is polyvinyl acetate (PVA) and/or polyvinyl butyral (PVB).

14. The method of claim 10, wherein the involute stack of fabric plies is conical.

15. The method of claim 10, wherein the involute stack of fabric plies forms a full hoop.

16. The method of claim 15, wherein an orientation of plies in the involute stack of fabric plies relative to an axis of the full hoop is selected based upon strength and/or performance requirements of the airfoil component after densifying the preform.

17. A method of forming a full hoop ceramic matrix composite (CMC) component, comprising:
forming a full hoop preform by:
stacking a plurality of inwardly-curved tackified fabric plies in a partially overlapping manner to form a hoop-shaped involute stack of fabric plies;
machining an inner diameter (ID) surface and an outer diameter (OD) surface of the involute stack of fabric plies to remove lap joint discontinuities;
overwrapping the ID surface with an inner mold layer overwrap formed of one or more tackified fabric plies; and
overwrapping the OD surface with an outer mold layer overwrap formed of one or more tackified fabric plies; and
densifying the full hoop preform to form the full hoop CMC component.

18. The method of claim 17, wherein a tackifier of the tackified fabric plies is polyvinyl acetate (PVA) and/or polyvinyl butyral (PVB).

19. The method of claim 18, wherein the hoop-shaped involute stack of fabric plies is conical.

20. The method of claim 17, wherein an orientation of plies in the hoop-shaped involute stack of fabric plies relative to an axis of the full hoop is selected based upon strength and/or
performance requirements of the full hoop CMC component after densifying the full hoop preform.
